(19) United States
(12) Patent Application Publication
(10) Pub. No.: US 2014/0068518 A1
(43) Pub. Date: Mar. 6, 2014

(54) METHOD AND DEVICE FOR SWITCHING APPLICATION PROGRAM OF TOUCH SCREEN TERMINAL

(71) Applicant: Tencent Technology (Shenzhen) Company Limited, Shenzhen city (CN)

(72) Inventors: Bo LIU, Shenzhen city (CN); Xiaobing Fu, Shenzhen city (CN)

(73) Assignee: Tencent Technology (Shenzhen) Company Limited, Shenzhen city (CN)

(21) Appl. No.: 14/076,854

(22) Filed: Nov. 11, 2013

Related U.S. Application Data
(63) Continuation of application No. PCT/CN2012/079751, filed on Aug. 7, 2012.

(30) Foreign Application Priority Data
Oct. 28, 2011 (CN) 2011103338425

(51) Int. Cl. G06F 3/0488; G06F 3/0481; G06F 3/0484

(52) U.S. Cl. CPC G06F 3/0488; G06F 3/04842; G06F 3/04817
USPC 715/835

(57) ABSTRACT

A method for switching application program in a touch screen terminal, comprising: in a running interface of an application program, displaying an application program switching window in a screen sweet area upon a condition that a lateral slide signal is detected which is triggered at a screen vertical edge of the screen sweet area and laterally slid to an opposite side of the screen vertical edge; upon a condition that the application program switching window is being displayed, quitting the application program switching window from the screen sweet area in the event that a lateral slide signal is detected which is triggered at an arbitrary point in the touch screen and laterally slid to the screen vertical edge of the screen sweet area; and switching to a corresponding application program in the event that a click signal to an application program icon within the application program switching window is detected.

### CROSS REFERENCE TO RELATED APPLICATIONS

This application is a continuation application of PCT application PCT/CN2012/079751, filed on Aug. 7, 2012, which claims foreign priority under 35 USC 119 to Chinese patent application No. 201110333842.5 filed on Oct. 28, 2011. The aforementioned patent applications are hereby incorporated by reference in their entirety.

### TECHNICAL FIELD

The present disclosure relates to techniques for operation and control of portable smart terminals, and in particular to a method and device for switching application program on a portable smart terminal (to be referred to as “touch screen terminal” herein) having a touch screen.

### BACKGROUND TECHNIQUES

Portable smart terminals, such as smart phones, palm PCs, and the like, are used more and more frequently today to such an extent that almost everyone possess one. These portable smart terminals are typically held for operation with a single hand, and thus a special requirement is needed for the techniques for operation and control of them, i.e. with the body of the portable smart terminal being held with a single hand, the portable smart terminal can be conveniently operated and controlled (collectively referred to as “manipulated” herein) with the thumb or finger of that hand.

Portable smart terminals are manipulated typically in two manners, either through a hardware button or through a touch screen. In order to display a larger and more versatile human-machine interface, the screen of portable smart terminal is getting larger and larger, resulting in a size reduction of button accordingly. Typically in a currently popular smart phone, only two or three hardware buttons remain in a lower part of its body, and other operations are carried out through a touch screen.

With the improvement of the processing capability in hardware of portable smart terminals, the number of the application programs (APPs) capable of running on them is also increasing. Today a technique named application program switcher (APP switcher) is available on portable smart terminals, also known as Task Switcher. APP switcher is an application program switching window on a terminal for presenting icons of the application programs that were recently run on this portable smart terminal; if an icon for an application program is clicked, then the corresponding application program is launched, and thereby switching of application programs is achieved on the portable smart terminal.

In prior art, different operating systems of touch screen terminals have different solutions for displaying and quitting APP switchers on the touch screen terminals to switch application programs. The solutions mainly include the following.

(1) Application Program Switching Implemented in iOS Operating System

FIG. 1 shows an illustration of an interface that implements application program switching in iOS operating system in a prior art smart phone, iPhone. With reference to FIG. 1, when an application program is running, if the iOS operating system detects a double click signal to a hardware Home button 101, an APP switcher 103 (the portion inside the dotted line frame shown in the bottom of the screen), in which icons for the application programs that were used recently are displayed, is displayed in the bottom of the current screen, i.e. the bottom of an interface of the currently running application program 102, and when the operating system detects a click signal to an icon for a certain application program, the application program corresponding to that icon is launched and thus switching between application programs is achieved.

(2) Application Program Switching Implemented in Android Operating System

FIG. 2 shows an illustration of an interface that implements application program switching in prior art android operating system. In this solution, if, when an application program is running, the android operating system detects a long-push signal to a hardware Home button 201, an APP switcher 203 (the portion inside the dotted line frame shown in the screen), in which icons for the application programs that were used recently are displayed, is displayed in the current screen 202, and when a click signal to an icon for a certain application program is detected, the application program corresponding to that icon is launched and thus switching between application programs is achieved.

The above prior art techniques, however, have the following disadvantages.

Both iOS operating system and android operating system currently are triggered by hardware buttons to display an APP switcher. However, when a touch screen terminal is being used, most of user operations are carried out on the touch screen in a form of gesture touching, and thus it is operationally inconvenient to change to a hardware button operation. Meanwhile, either long-push or double click requires a certain period of time, and thus the APP switcher cannot be displayed promptly and the requirement from a user for a quick switching between application programs cannot be fulfilled. In addition, for either of prior art iOS operating system and android operating system, it has to be implemented in hardware, i.e. by pressing the hardware Home button (for iOS and android operating systems) or by pressing a hardware Back button (for android operating system), to return to the previous application program after displaying and quitting the APP switcher, and this changing to the hardware button operation will also bring operational inconvenience to the user.

### SUMMARY OF THE INVENTION

An object for the disclosure is to provide a method and device for switching application program of touch screen terminal to improve the convenience and quickness of the operation of switching application programs on the touch screen terminal.

The object of the disclosure is achieved by the following technical solutions:

A method for switching application program in a touch screen terminal, comprising:

in a running interface of an application program, displaying an application program switching window in a screen sweet area upon a condition that a lateral slide signal is detected which is triggered at a screen vertical edge of the screen sweet area and laterally slid to an opposite side of the screen vertical edge;

upon a condition that the application program switching window is being displayed, quitting the application program switching window from the screen sweet area in the event that a lateral slide signal is detected which is triggered at an arbitrary point in the touch screen and laterally slid to the screen vertical edge of the screen sweet area; and switching to a corresponding application program in the event that a click signal to an application program icon within the application program switching window is detected.

A device for switching application program in a touch screen terminal, comprising:

a display control module for displaying and controlling content on a screen;

a first signal detection module for triggering the display control module to display, in a running interface of an application program, an application program switching window in a screen sweet area upon a condition that a lateral slide signal is detected which is triggered at a screen vertical edge of the screen sweet area and laterally slid to an opposite side of the screen vertical edge;

a second signal detection module for detecting, upon a condition that the display control module is displaying the application program switching window, a lateral slide signal which is triggered at an arbitrary point in the touch screen and laterally slid to the screen vertical edge of the screen sweet area, and triggering the display control module to quit the application program switching window in the screen sweet area upon a condition that the lateral slide signal is detected; and

a third signal detection module for detecting, upon a condition that the display control module is displaying the application program switching window, a click signal to an application program icon within the application program switching window, and triggering the display control module to switch to a corresponding application program in the event that the click signal is detected.

In comparison with the prior art, display of the APP switcher is triggered in the present disclosure by the detection of a slide signal in the screen sweet area, i.e. a slide gesture, and it is not necessary to long-push or double click a hardware button; in addition, the screen sweet area is an area in which a user can easily touch and operate with his/her thumb or finger, and as such with the present disclosure, a user using a touch screen terminal can carry out the operation of switching application programs more conveniently and promptly. Meanwhile, since the slide signal for displaying the APP switcher has its original point provided at a screen vertical edge in the screen sweet area, a misoperation due to an unintentional lateral slide can be avoided. The invention may also be implemented as a non-volatile computer-readable medium having instructions stored thereon, the instructions when being executed causing one or more processing units to perform the operations of the method according to the present disclosure.

### BRIEF DESCRIPTION OF THE DRAWINGS

For a clear description of the technical solutions of the embodiments according to the invention, the drawings involved in the description of the embodiments will be briefly described which, however, are merely exemplary embodiments of the invention, and a person ordinarily skilled in the art can derive other drawings from these drawings without the necessity of an inventive effort.

FIG. 1 shows an illustration of an interface that implements application program switching in iOS operating system in a prior art smart phone, iPhone;

FIG. 2 shows an illustration of an interface that implements application program switching in prior art android operating system;

FIG. 3 shows a flow chart of a method for switching application program in a touch screen terminal according to the disclosure;

FIG. 4 shows a flow chart of an embodiment of the method for switching application program in a touch screen terminal according to the disclosure;

FIG. 5a shows an illustration of a running interface of an application program prior to displaying an application program switching window;

FIG. 5b shows a screen interface displaying an application program switcher;

FIG. 5c shows a screen interface displaying an application program switcher in a landscape mode;

FIG. 5d shows a screen interface displaying an application program switcher which is adaptive to a left-hander and in which a sweet area is at the left side;

FIG. 6 shows the components of an application program switching device according to the disclosure; and

FIG. 7 is a block diagram showing internal components of a touch screen terminal 700 according to the embodiments of the disclosure.

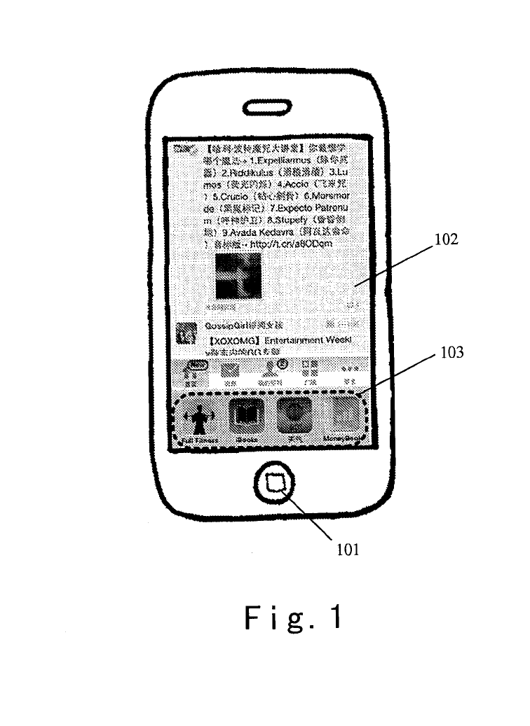

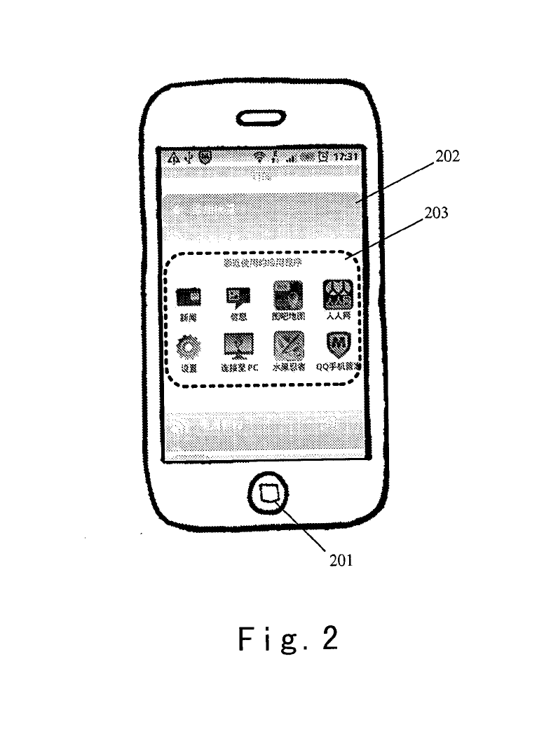

### DETAILED DESCRIPTION OF EMBODIMENTS OF THE INVENTION

The technical solutions of the embodiments according to the invention will be clearly and comprehensively described with reference to the drawings; apparently what is described is only a part, instead of all, of the embodiments of the invention. A person ordinarily skilled in the art may derive, based on the embodiments of the invention without an inventive effort, other embodiments all of which should be within the scope of the invention.

The embodiments of the invention will be further described in the following with reference to the drawings.

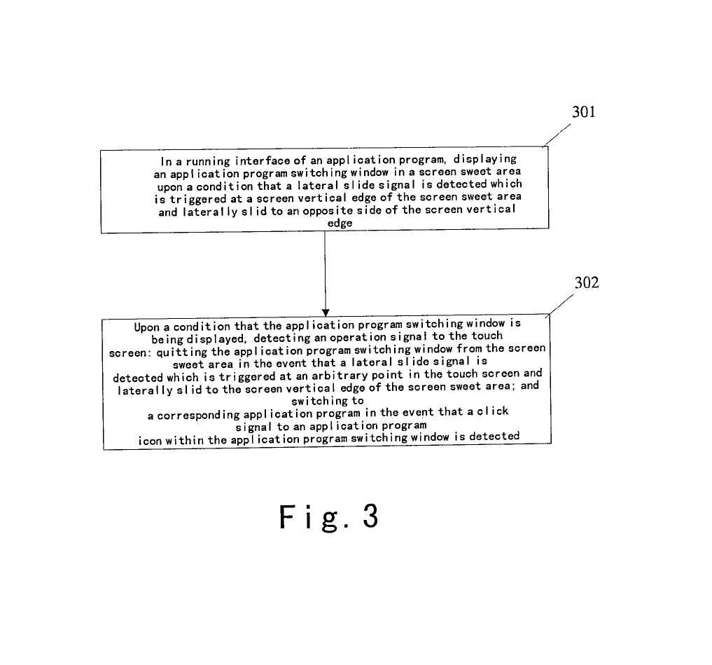

FIG. 3 shows a flow chart of a method for switching application program in a touch screen terminal according to the disclosure. With reference to FIG. 3, the flow comprises:

Step 301: in a running interface of an application program, displaying an application program switching window in a screen sweet area upon a condition that a lateral slide signal is detected which is triggered at a screen vertical edge of the screen sweet area and laterally slid to an opposite side of the screen vertical edge;

Step 302: upon a condition that the application program switching window is being displayed, detecting an operation signal to the touch screen: quitting the application program switching window from the screen sweet area in the event that a lateral slide signal is detected which is triggered at an arbitrary point in the touch screen and laterally slid to the screen vertical edge of the screen sweet area; and switching to a corresponding application program in the event that a click signal to an application program icon within the application program switching window is detected.

In the context of the disclosure, a screen sweet area refers to such an area on the screen of a touch screen terminal in which a user can easily touch and operate with his/her thumb or finger. A majority of people operates a touch screen terminal with his/her right hand, and as such the right-hand area of the screen can be used as the screen sweet area in typical embodiments; in order to meet the requirement of left-handers, however, the left-hand area of the screen may be used as the screen sweet area in another embodiment.

The invention will be described in the following in such an example that the right-hand area of the screen is used as the screen sweet area.

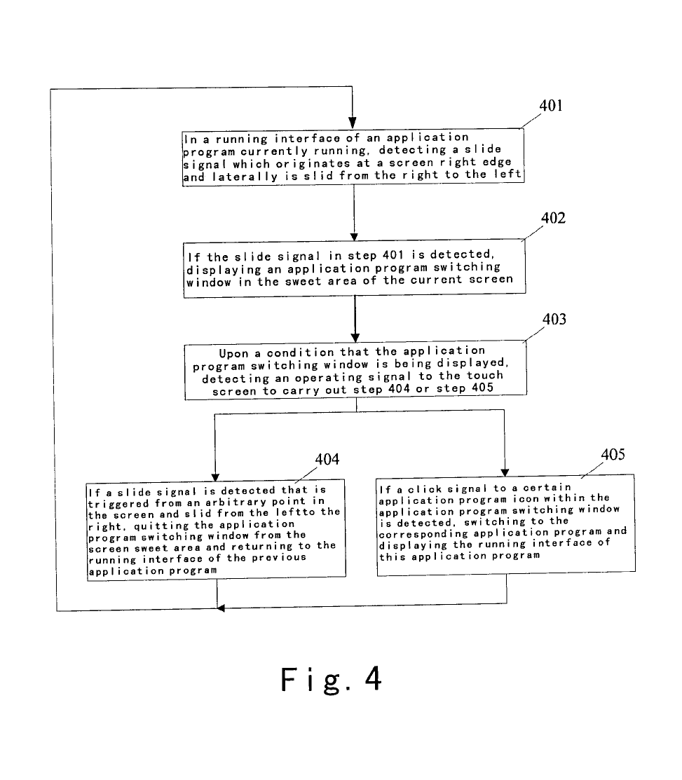

FIG. 4 shows a flow chart of an embodiment of the method for switching application program in a touch screen terminal according to the disclosure. With reference to FIG. 4, the flow comprises:

Step 401: in a running interface of an application program currently running, detecting a lateral slide signal which is triggered at a screen right edge of the touch screen terminal (since the right-hand area of the screen is used as the screen sweet area in the embodiment, the screen vertical edge of the screen sweet area is the right edge of the screen) and laterally slid from the right to the left (i.e. an opposite side of the screen vertical edge) of the screen vertical edge; in other words, the slide signal originating from the right edge of the screen and slid from the right to the left is to be detected.

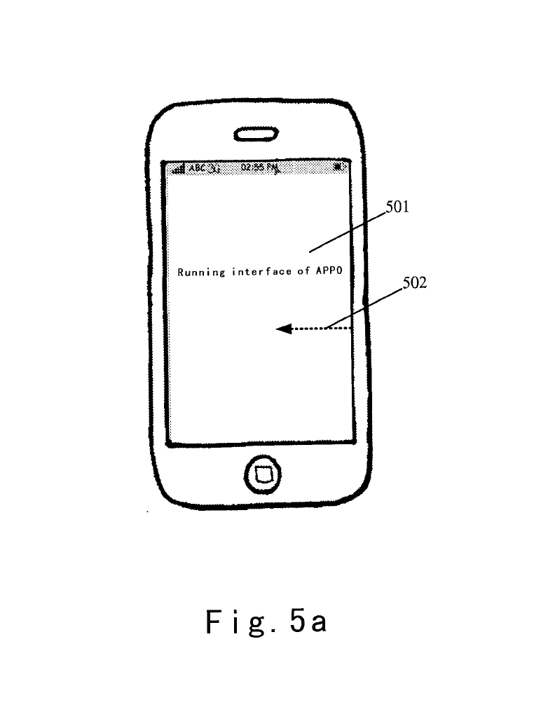

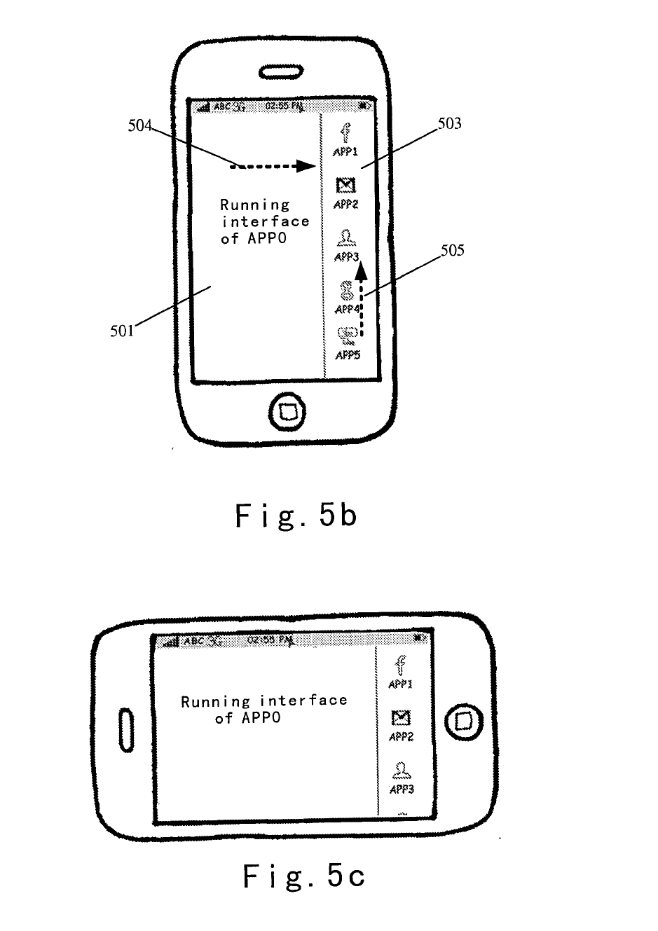

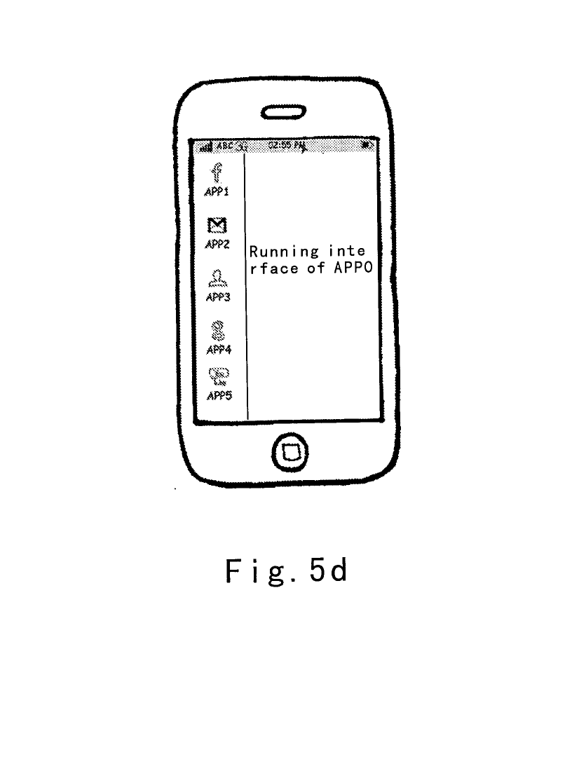

The step 401 is typically carried out when the touch screen terminal is executing an application program; in other words, the step 401 is carried out in a running interface of an application program, to achieve switching between application programs. FIG. 5a shows an illustration of a running interface of an application program prior to displaying an application program switching window. With reference to FIG. 5a, in a running interface 501 of a currently running application program (APPO in the drawing), a lateral slide signal originating from the right edge of the screen and slid from the right to the left is detected; the arrow 502 in dotted line as shown in FIG. 5a indicates a lateral slide signal.

In the step 401, the original position of the detected slide signal is a right edge of the screen, i.e. a screen vertical edge of the screen sweet area; otherwise, if the original position of a slide signal is not the screen vertical edge of the screen sweet area, it is determined as a right-left slide signal inside the current application program, and display of the application program switching window is not triggered.

Step 402: if the lateral slide signal in step 401 is detected, displaying in the sweet area of the current screen an application program switching window, in which application program icons for program switching are included; the application program switching window may be referred to as an APP switcher.

FIG. 5b shows a screen interface displaying an application program switcher. With reference to FIG. 5b, in the embodiment the screen sweet area is on a right-hand side of the screen, and the application program switching window may be displayed in the screen sweet area specifically by: displaying a switching window 503 of the APP switcher in the screen sweet area, the switching window 503 being a portrait-oriented window in which application program icons are displayed from the top down in an order as to how recent the corresponding application programs were used (in another embodiment, the application program icons may be displayed from the bottom up in that order): the more recent an application program was used, the upper the corresponding icon is positioned.

Displayed in the left-hand side of the screen is a partial interface of the currently running application program, that is, the APP switcher floats over the interface of the currently running application program; when the APP switcher is being displayed, the currently running application program is switched to background and will not respond to the operating signal to the touch screen.

Step 403: upon a condition that the application program switching window is being displayed, detecting an operating signal to the touch screen to carry out step 404 or step 405.

Step 404: if a lateral slide signal is detected that is triggered from an arbitrary point in the screen and laterally slid to the screen vertical edge of the screen sweet area (which is a lateral slide signal triggered at an arbitrary point in the screen and slid from the left to the right as shown in FIG. 5b by the arrow 504 in dotted line), quitting the application program switching window from the screen sweet area and returning to the running interface of the previous application program, i.e. the running interface 501 in FIG. 5a; then it goes back to step 401 for subsequent detections.

Step 405: if a click signal to a certain application program icon within the application program switching window is detected, switching to the corresponding application program and displaying the running interface of this application program; then it goes back to step 401 for subsequent detections.

In addition, upon a condition that the application program switching window is being displayed, if a count number of the icons for recently used application programs is greater than a count number of application program icons that can be included in the application program switching window, the application program icons that can be included in the application program switching window are displayed on the application program switching window; the method may further comprise: detecting a vertical slide signal, and if detected (a vertical slide signal 505 as shown in FIG. 5b), the icons for switching the application programs are scrolled in the application program switching window in accordance with the slide direction, thereby it can be realized that the user slides a list of the application program icons up and down to select an application program to be switched to.

The embodiment of FIGS. 5a and 5b above shows a manner of displaying the application program switching window in a portrait mode. In a landscape mode, the operation of displaying the application program switching window is the same as the above embodiment, as the application program switching window is displayed when a signal triggered at a right edge of the screen and slid to the left is detected, and is quitted when a lateral slide signal triggered at an arbitrary point in the screen and slid from the left to the right is detected; the only difference is that there will be less application program icons that can be presented in the vertical switching window, as shown in FIG. 5c.

The embodiments shown in FIGS. 4, 5a, 5b and 5c illustrate the invention by using the right-hand area of the screen as the screen sweet area to adapt to a user requirement of right-handers. In order to meet the requirement of left-hander users, in another embodiment, the left-hand area of the screen may be used as the screen sweet area; while an application is running, when a lateral slide signal is detected which is triggered at the left edge of the screen and slid from the left to the right, icons for switching application programs are displayed in the screen sweet area, as shown in FIG. 5d; while the icons for switching application programs are being displayed, if a lateral slide signal is detected which is triggered at an arbitrary point in the screen and slid from the right to the left, the icons for switching application programs are quitted from the screen sweet area.

Detection of the lateral slide signal or vertical slide signal on the touch screen may be achieved with existing techniques for touch screen gesture identification, and may be implemented by invoking a corresponding gesture identification interface of an existing touch screen operating system. The touch screen gesture identification techniques generally make a sequential sampling on the touch screen at a predetermined frequency (with a small interval between periods) to obtain coordinates for the track of a gesture operation, and determine an original position and direction of the detected slide signal based on the coordinates for the track. When determining the direction of the slide signal, it is not necessary to strictly determine whether it is slid horizontally in a right-left direction or vertically in an up-down direction. As long as the line connecting the coordinates for the track of the gesture is within a specified range of angles with respect to the lateral direction, it is determined as a left or right lateral slide; as long as the line connecting the coordinates for the track of the gesture is within a specified range of angles with respect to the vertical direction, it is determined as an up or down vertical slide.

The disclosure provides a solution of switching fully by touch screen gesture manipulation, which does not involve manipulation through a hardware button and thus a hardware responding period is not needed, it is more convenient and quick for a user. Misoperation can be avoided by the determination of the original point of the gesture. Meanwhile, since a user of a touch screen terminal usually operates the terminal with a single hand, with the disclosure a user can trigger the display of the application program switching window very conveniently by detecting a corresponding touch signal in the screen sweet area (the area that can be easily touched and operated with a thumb or finger), and can select a certain application program or scroll a list of icons of application programs up and down very conveniently as the application program switching window is in the sweet area.

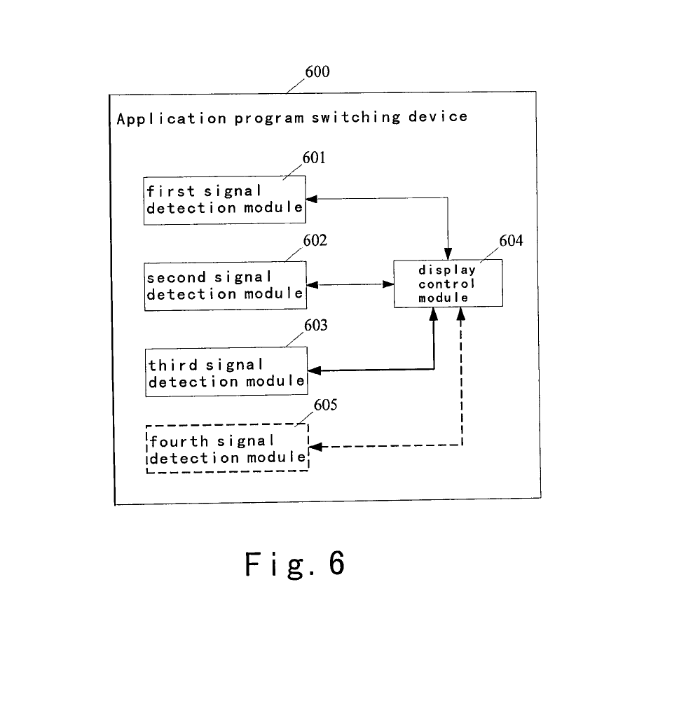

Based on the above method, a device for switching application program in a touch screen terminal is proposed in the disclosure. FIG. 6 shows the components of the application program switching device according to the disclosure. As shown in FIG. 6, the device 600 comprises:

a display control module 604 for displaying and controlling content on a screen;

a first signal detection module 601 for detecting, in a running interface of an application program, a lateral slide signal which is triggered at a screen vertical edge of a screen sweet area and laterally slid to an opposite side of the screen vertical edge, and triggering the display control module 604 to display an application program switching window in the screen sweet area upon a condition that the lateral slide signal is detected;

a second signal detection module 602 for detecting, when the display control module 604 is displaying the application program switching window, a lateral slide signal which is triggered at an arbitrary point in the screen and laterally slid to the screen vertical edge of the screen sweet area, and triggering the display control module 604 to quit the application program switching window in the screen sweet area upon a condition that the lateral slide signal is detected; and

a third signal detection module 603 for detecting, when the display control module 604 is displaying the application program switching window, a click signal to an application program icon within the application program switching window, and triggering the display control module 604 to switch to a corresponding application program in the event that the click signal is detected.

As shown in FIG. 5b, the display control module 604 may display the application program switching window in the screen sweet area specifically by: displaying a switching window 503 of the APP switcher in the screen sweet area, the switching window 503 being a portrait-oriented window in which application program icons are displayed from the top down in an order as to how recent the corresponding application programs were used (in another embodiment, the application program icons may be displayed from the bottom up in that order): the more recent an application program was used, the upper the corresponding icon is positioned.

When the application program switching window is being displayed, if the number of the icons for recently used application programs is greater than the number that can be included in the switching window, the display control module 604 displays in the current switching window only the application program icons of the number that can be included.

As such, in a further embodiment, the device 600 further comprises:

A fourth signal detection module 605 for detecting a vertical slide signal when the display control module is displaying the application program switching window and the number of the icons for application programs is greater than the number that can be included in the switching window, and triggering, upon a condition that the vertical slide signal is detected, the display control module 604 to scroll the icons for application programs in accordance with the slide direction.

In order to meet the requirement of right-hander users, in an embodiment, the screen sweet area is in a right-hand vertical area of the screen; the lateral slide signal triggered at a screen vertical edge of the screen sweet area and laterally slid to an opposite side of the screen vertical edge, which is detected by the first signal detection module 601, is a lateral slide signal triggered at a right edge of the screen and slide from the right to the left; the lateral slide signal triggered at an arbitrary point in the screen and laterally slid to the screen vertical edge of the screen sweet area, which is detected by the second signal detection module 602, is a lateral slide signal triggered at an arbitrary point in the screen and slide from the left to the right.

In order to meet the requirement of left-hander users, in another embodiment, the screen sweet area is in a left-hand vertical area of the screen; the lateral slide signal triggered at a screen vertical edge of the screen sweet area and laterally slid to an opposite side of the screen vertical edge, which is detected by the first signal detection module 601, is a lateral slide signal triggered at a left edge of the screen and slide from the left to the right; the lateral slide signal triggered at an arbitrary point in the screen and laterally slid to the screen vertical edge of the screen sweet area, which is detected by the second signal detection module 602, is a lateral slide signal triggered at an arbitrary point in the screen and slide from the right to the left.

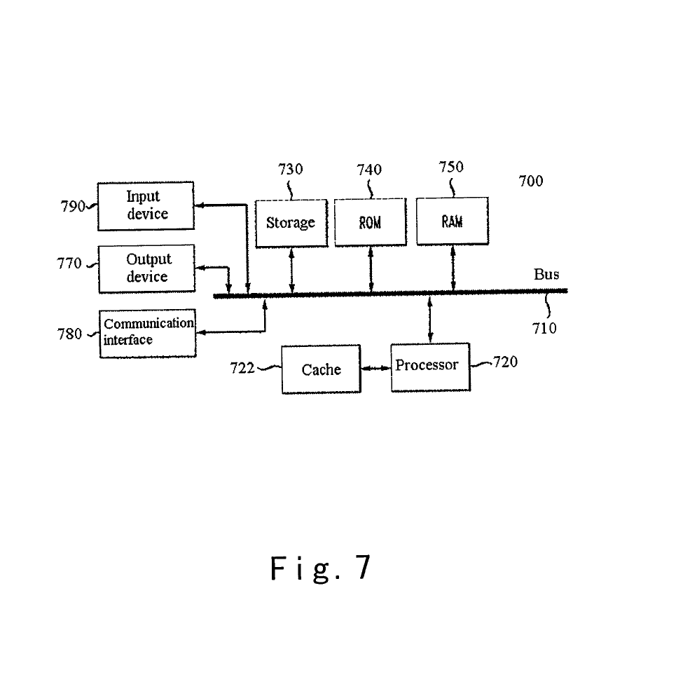

FIG. 7 is a block diagram showing internal components of a touch screen terminal 700 according to the embodiments of the disclosure. The touch screen terminal 700 comprises a bus 710 coupling various components as described below. The touch screen terminal 700 comprises a processor 720, which may be one or more central processing unit(s) each having one or more processing cores, graphical processing unit(s) or other processing element(s). The touch screen terminal 700 may comprise a cache 722 coupled to the processor 720 or integrated as a part of the processor 720. The touch screen terminal 700 comprises a system memory, for example read only memory (ROM) 740 and random access memory (RAM) 750. The touch screen terminal may further comprise a storage 730, which may be a non-volatile computer-readable medium, such as an optical disk, a magnetic disk (e.g. hard disk or floppy disk), an opto-magnetic disk, a flash memory, and the like. Data may be copied to the cache 722 from storage 730, ROM 740 or RAM 750 to avoid delay in the processor 720 waiting for data and to thereby improve the overall performance.

In the touch screen terminal 700, the touch screen serves as both an input device and an output device. In addition to the touch screen, the touch screen terminal 700 may further comprise at least one input device 790 for interaction between a user and the touch screen terminal 700. The input device 790 may be, for example, keypad, mouse, motion input, image capturing element, gravity sensor, voice receiving element, and so on. The touch screen terminal 700 may comprise at least one output device 770, which may be common output mechanisms as well known for those skilled in the art, e.g. speaker, beeper, flash light, image projecting element, vibration output element, or a further display screen. The touch screen terminal 700 may comprise a communication interface 780 for data communication in a wired or wireless manner. For example, the communication interface may comprise an antenna for transmitting and receiving data based on various cellular protocols, Wi-Fi, Bluetooth, infrared, or Near Field Communication (NFC), and/or comprise a hardware socket based on USB (including micro-USB, mini-USB, etc.), FireWire, HDMI, Lightning, and the like.

In an embodiment, the present invention may be implemented as a non-volatile computer-readable medium (e.g. the storage 730) having instructions stored thereon, the instructions when being executed causing one or more processing units (e.g. the processor 720) to perform operations as described in the embodiments above.

What is described above is directed to some of the embodiments according to the invention. The scope of the invention is not limited thereto however, and a person skilled in the art could, with the technical disclosure of the invention, conceive of various modifications and alternatives, which is to be covered in the scope of the invention. The extent of protection of the invention should therefore be determined by the claims.

### INDUSTRIAL APPLICABILITY

With the method and device for switching application program on a touch screen terminal, display of the APP switcher is triggered by the detection of a slide signal in the screen sweet area, i.e. a slide gesture, and it is not necessary to long-push or double click a hardware button; in addition, the screen sweet area is an area in which a user can easily touch and operate with his/her thumb or finger, and as such with the present disclosure, a user using a touch screen terminal can carry out the operation of switching application programs more conveniently and promptly. Meanwhile, since the slide signal for displaying the APP switcher has its original point provided at a screen vertical edge in the screen sweet area, a misoperation due to an unintentional lateral slide can be avoided.

What is claimed is:

1. A method for switching application program in a touch screen terminal, comprising:
in a running interface of an application program, displaying an application program switching window in a screen sweet area upon a condition that a lateral slide signal is detected which is triggered at a screen vertical edge of the screen sweet area and laterally slid to an opposite side of the screen vertical edge;
upon a condition that the application program switching window is being displayed, quitting the application program switching window from the screen sweet area in the event that a lateral slide signal is detected which is triggered at an arbitrary point in the touch screen and laterally slid to the screen vertical edge of the screen sweet area; and
switching to a corresponding application program in the event that a click signal to an application program icon within the application program switching window is detected.

2. The method according to claim 1, wherein displaying in the screen sweet area the application program switching window comprises:
displaying the application program switching window in the screen sweet area, wherein in the application program switching window, application program icons are displayed from the top down or from the bottom up in an order as to how recent the corresponding application programs were used.

3. The method according to claim 2, further comprising:
upon a condition that the application program switching window is being displayed, if a count number of the application program icons is greater than a count number of application program icons that can be included in the application program switching window, displaying the application program icons that can be included in the application program switching window on the application program switching window; and
if a vertical slide signal is detected, scrolling the application program icons in the application program switching window in accordance with the slide direction.

4. The method according to claim 1, wherein:
the screen sweet area is on a right-hand side of the touch screen;
the detected lateral slide signal triggered at the screen vertical edge of the screen sweet area and laterally slid to the opposite side of the screen vertical edge is a lateral slide signal triggered at a right edge of the touch screen and slid from the right to the left; and
the detected lateral slide signal triggered at the arbitrary point in the touch screen and laterally slid to the screen vertical edge of the screen sweet area is a lateral slide signal triggered at the arbitrary point in the touch screen and slid from the left to the right.

5. The method according to claim 1, wherein:
the screen sweet area is on a left-hand side of the touch screen;
the detected lateral slide signal triggered at the screen vertical edge of the screen sweet area and laterally slid to the opposite side of the screen vertical edge is a lateral slide signal triggered at a left edge of the touch screen and slid from the left to the right; and
the detected lateral slide signal triggered at the arbitrary point in the touch screen and laterally slid to the screen vertical edge of the screen sweet area is a lateral slide signal triggered at the arbitrary point in the touch screen and slid from the right to the left.

6. The method according to claim 1, wherein the slide signal is detected by invoking a gesture identification interface of a touch screen operating system to detect the lateral slide signal or a vertical slide signal.

7. A device for switching application program in a touch screen terminal, comprising:
a display control module for displaying and controlling content on a screen;
a first signal detection module for detecting, in a running interface of an application program, a lateral slide signal which is triggered at a screen vertical edge of a screen sweet area and laterally slid to an opposite side of the screen vertical edge, and triggering the display control module to display an application program switching window in the screen sweet area upon a condition that the lateral slide signal is detected;
a second signal detection module for detecting, upon a condition that the display control module is displaying the application program switching window, a lateral slide signal which is triggered at an arbitrary point in the touch screen and laterally slid to the screen vertical edge of the screen sweet area, and triggering the display control module to quit the application program switching window in the screen sweet area upon a condition that the lateral slide signal is detected; and
a third signal detection module for detecting, upon a condition that the display control module is displaying the application program switching window, a click signal to an application program icon within the application program switching window, and triggering the display control module to switch to a corresponding application program in the event that the click signal is detected.

8. The device according to claim 7, further comprising:
a fourth signal detection module for detecting a vertical slide signal upon a condition that the display control module is displaying the application program switching window and a count number of the icons for application programs is greater than a count number of application program icons that can be included in the application program switching window, and triggering, in the event that the vertical slide signal is detected, the display control module to scroll the application program icons in accordance with the slide direction.

9. The device according to claim 7, wherein:
the screen sweet area is on a right-hand side of the touch screen;
the lateral slide signal detected by the first signal detection module that is triggered at the screen vertical edge of the screen sweet area and laterally slid to the opposite side of the screen vertical edge is a lateral slide signal triggered at a right edge of the touch screen and slid from the right to the left; and
the lateral slide signal detected by the second signal detection module that is triggered at the arbitrary point in the touch screen and laterally slid to the screen vertical edge of the screen sweet area is a lateral slide signal triggered at the arbitrary point in the touch screen and slid from the left to the right.

10. The device according to claim 7, wherein:
the screen sweet area is on a left-hand side of the touch screen;
the lateral slide signal detected by the first signal detection module that is triggered at the screen vertical edge of the screen sweet area and laterally slid to the opposite side of the screen vertical edge is a lateral slide signal triggered at a left edge of the touch screen and slid from the left to the right; and
the lateral slide signal detected by the second signal detection module that is triggered at the arbitrary point in the touch screen and laterally slid to the screen vertical edge of the screen sweet area is a lateral slide signal triggered at the arbitrary point in the touch screen and slid from the right to the left.

11. The device according to claim 7, wherein in the application program switching window, application program icons are displayed from the top down or from the bottom up in an order as to how recent the corresponding application programs were used.

12. The device according to claim 7, wherein the lateral slide signal is detected by invoking a gesture identification interface of a touch screen operating system.

13. A non-volatile computer-readable medium having instructions stored thereon, the instructions when being executed causing one or more processing units to perform operations comprising:
in a running interface of an application program, displaying an application program switching window in a screen sweet area upon a condition that a lateral slide signal is detected which is triggered at a screen vertical edge of the screen sweet area and laterally slid to an opposite side of the screen vertical edge;
upon a condition that the application program switching window is being displayed, quitting the application program switching window from the screen sweet area in the event that a lateral slide signal is detected which is triggered at an arbitrary point in the touch screen and laterally slid to the screen vertical edge of the screen sweet area; and
switching to a corresponding application program in the event that a click signal to an application program icon within the application program switching window is detected.

14. The non-volatile computer-readable medium according to claim 13, wherein displaying in the screen sweet area the application program switching window comprises:
displaying the application program switching window in the screen sweet area, wherein in the application program switching window, application program icons are displayed from the top down or from the bottom up in an order as to how recent the corresponding application programs were used.

15. The non-volatile computer-readable medium according to claim 14, wherein the operations further comprise:
upon a condition that the application program switching window is being displayed, if a count number of the application program icons is greater than a count number of application program icons that can be included in the application program switching window, displaying the application program icons that can be included in the application program switching window on the application program switching window; and
if a vertical slide signal is detected, scrolling the application program icons in the application program switching window in accordance with the slide direction.

16. The non-volatile computer-readable medium according to claim 13, wherein:
the screen sweet area is on a right-hand side of the touch screen;
the detected lateral slide signal triggered at the screen vertical edge of the screen sweet area and laterally slid to the opposite side of the screen vertical edge is a lateral slide signal triggered at a right edge of the touch screen and slid from the right to the left; and
the detected lateral slide signal triggered at the arbitrary point in the touch screen and laterally slid to the screen vertical edge of the screen sweet area is a lateral slide signal triggered at the arbitrary point in the touch screen and slid from the left to the right.

17. The non-volatile computer-readable medium according to claim 13, wherein:
the screen sweet area is on a left-hand side of the touch screen;
the detected lateral slide signal triggered at the screen vertical edge of the screen sweet area and laterally slid to the opposite side of the screen vertical edge is a lateral slide signal triggered at a left edge of the touch screen and slid from the left to the right; and
the detected lateral slide signal triggered at the arbitrary point in the touch screen and laterally slid to the screen vertical edge of the screen sweet area is a lateral slide signal triggered at the arbitrary point in the touch screen and slid from the right to the left.

18. The non-volatile computer-readable medium according to claim 13, wherein the slide signal is detected by invoking a gesture identification interface of a touch screen operating system to detect the lateral slide signal or a vertical slide signal.
